(19) United States
(12) Patent Application Publication
(10) Pub. No.: US 2003/0024151 A1
(43) Pub. Date: Feb. 6, 2003

(54) Adhesive dispensing collector

(76) Inventor: Richard L. Kremer, Cheyenne, WY (US)

Correspondence Address: RICHARD KREMER, 1710 PERSONS ROAD, CHEYENNE, WY, 82007, US

(21) Appl. No.: 09/921,770

(22) Filed: Aug. 3, 2001

(51) Int. Cl. A01M 3/04; A01M 5/02

(52) U.S. Cl. 43/136

(57) ABSTRACT

Various types of adhesive-dispensing swatters are disclosed for collecting a variety of pests. The swatters include components for dispensing water-soluble adhesives and applying same to a collecting surface. Insects or pests can be released alive by promptly washing with water to dissolve the adhesive. Some of the devices include water-soluble components to facilitate their disposal by flushing.

### BACKGROUND OF THE INVENTION

Since the time when cave man swatted flies by hand, mankind has tried to invent devices and ways to reduce and control insects. Fly swatters of many kinds and complexities have been devised wherein smashing is used. Adhesive “fly paper” collectors and adhesive swatters collect pests but doom the pests to an unsanitary, slow, agonizing demise. Insecticides and poisons including D.D.T. have been used that have repercussions to all of mankind.

1. Fields of the invention

This invention relates generally to the field of pest collection and more particularly to articles of manufacture for adhesively collecting pests and methods for using same.

2. Discussion of the Relevant Art

The sheer volume of inventions encouraging or requiring the smashing of flies and spring smashing of rodents points the way for a need to improve. U.S. Pat. No. 4,907,367 is an example of a device to reduce the degree of smashing. U.S. Pat. No. 4,653,222 is a device that includes insecticide to overcome a further need.

U.S. Pat. Nos. 5,207,018 and 4,899,485 are patents mentioning water, drowning insects or release from a trap. Soluble adhesive is not used. Methods using water to release insects alive or drowning them are mentioned.

A myriad of inventions have been devised to incrementally improve the technology of collecting, instead of smashing, pests. Adhesive and glue have been presented as an improvement. Instead, a set of different problems arose, needing a solution. Adhesive collection methods, whether by “fly paper”, glue traps, or adhesive swatters, all doom pests to an agonizing slow death. They are not sanitary or recommended in restaurants or around children.

U.S. Pat. No. 4,411,093 explains non-drying adhesive formulations. U.S. Pat. No. 4,424,642 discloses water strippable adhesives. The method of use claimed is different from the present invention.

U.S. Pat. No. 4,136,798 is for a flushable bedpan bag, not a flushable fly swatter as the present invention, but discloses water-soluble plastics. U.S. Pat. No. 4,899,485 discloses a device using water which is disposable. Dissolving is not included in the disposal method.

U.S. Pat. No. 5,398,442 is a combination glue trap and package containing a non-drying adhesive. It is not water soluble and it does not have an adhesive containment in a handle as in the present invention.

U.S. Pat. No. 6,102,457 is a pet waste disposal device that does dissolve in water and is flushable. The purpose and method of use are not at all like the proposed invention. U.S. Pat. No. 3,828,776 is a teat disinfecting cup having a cup and dispensing handle combination. The use is not similar and no adhesive is dispensed. It is not suitable to be flushed down a sewer.

In Organic Gardening in 1973 an article (“Getting the Bugs Out of Organic Gardening”) mentioned setting out paper plates with molasses or honey to catch crawling garden insects. Honey and molasses are water soluble but this method is not mentioned as releasing insects alive. No patent was found mentioning dissolving adhesive or dissolving a swatter element. Out of what seems like thousands of patents on pest collecting, not one mentioned or claimed a dispensing handle stand base or water soluble cartridge as in the present invention.

Deficiencies in the prior art include the mess and disease spread by swatter smashing or spring on a board smashing of rodent pests. Restaurants, hospitals and “clean room” environments are encouraged not to use smashing and are even outlawed from the smashing of pests. Adhesive collection methods for pests were devised, such as “fly paper”, “glue traps”, and adhesive swatters. The collected pests die an agonizing and slow death. The decaying dead pests spread disease. Swatter smashing of pests requires a waste of time waiting for the pests to alight on some surface. The prior methods did not include any means to sanitize such as washing.

### OBJECTS OF THE INVENTION

The primary object of the invention is to provide a method that overcomes the stated prior art deficiencies and lack of sanitation of swatter smashing flies.

Another object of the invention is to provide a device wherein, because insects are not smashed, restaurants, hospitals, nurseries and “clean rooms” can sanitarily and legally use this invention.

A further object of the invention is to provide methods of disposing of insects and debris in a sanitary manner by washing.

Another object of the invention is to provide a device wherein, because flying insects can be accumulated in midair, time is not wasted waiting for the insects to contact the device or alight on a surface.

Yet another object of the invention is to present an invention wherein pest collections can be released when flushed with water. The cartridge can be renewed or disposed of in the trash, as a clean cartridge. Furthermore, the cartridge can dissolve to be flushable down a sink or toilet.

Still another object of the invention is a device wherein the renewing adhesive substance is conveniently stored in the handle for easy reapplication and extended shelf life. This improvement overcomes the single largest reason why adhesive swatters have not caught on in the marketplace. The handle can also be used as a stand when set on end.

A further object of the invention is to design a device wherein the adhesive does not need to be non-drying because it is applied at the time of use. Thus, even drying adhesives can be used soon after application, for as long as they maintain sufficient tack.

A further object of the invention is to design a product wherein adhesive is applied after market to assure that deliveries in large quantities do not end up adhering a truckload of merchandise together when package damage occurs.

Another object of the invention is to provide a device wherein the tacky adhesive substance is applied after market to a clean, sanitary surface, allowing the clean collector to be left standing on a restaurant table for use by guests to sanitarily remove pests landing on served food.

Another object of the invention is to design a device that can employ injection molding processes for high volume, low cost manufacturing from inexpensive plastics.

A still further object of this invention is to present a device wherein the pest collecting adhesive dissolves at a much faster rate than the cartridge.

A further object of the invention is to design a cartridge that includes a lip or is dish shaped to create a lip that is designed to touch swatting surfaces. The tacky substance does not contact swatted surfaces. The lip is also water soluble.

Yet another object of the invention is to design an invention cartridge superior to “fly paper” and the use thereof because the collections are removed by washing. Optionally, the cartridge is renewed with tacky substance and later flushed down a sewer.

Still another object of the invention is to design an invention cartridge system having a myriad of uses as a rodent, roach, scorpion and crawling insect collecting cartridge, as well as a sample pollen and air borne seed collector. Also included is a use to collect all sorts of flying insects such as mosquitoes, flies, butterflies, moths, bees and wasps. A related object is to have handle dispenser components which interlock to form an extended handle and can be filled with adhesives selected or formulated for specific uses.

A further object of the invention is to develop an implement which can be used in collecting live insects and the like for entomology studies or lepidoptera collecting. A related object is to collect insects for animal or human food.

Another object of the invention is to design an invention that can be molded as a unitary device for some markets and used as a separable cartridge with handle extension, handle grip applicator and substance container as a combination in other markets.

Another object of the invention is to design a more humane method wherein collected pests are released alive instead of dying a slow agonizing death caught in a trap or “glue”.

A further object of the invention is to develop an invention that is easily, sanitarily and safely simple enough to be used by children.

Yet another object of the invention is to present an invention so simple and effective to use that lives will be saved and the spread of disease in third world countries will diminish. There is little need for extensive communications on effective use.

Still another object of the invention is to develop a device to further the technology and overcome the previous limitations of adhesively collecting pests, designed to make the substance and/or the cartridge pest releasable.

Another object of the invention is to develop a collector that uses no insecticides, poisons or harmful chemicals.

Another object of the invention is to develop an invention wherein people allergic to bee, wasp and scorpion stings, can safely and effectively collect such insects, possibly saving more lives.

A further object of the invention is to develop a device usable on crawling, leaping, poisonous spiders, at a distance.

Other objects and advantages of the present invention will become apparent from the following descriptions, taken in connection with the accompanying drawings, wherein, by way of illustration and example, preferred embodiments of the present invention are disclosed.

### SUMMARY OF THE INVENTION

In accordance with the present invention, an adhesive dispensing swatter for collecting insects and/or other pests and method for using same is provided, comprising: substantially a two component cartridge, one component including a predetermined water soluble collection front surface component, and an opposed back component with the cartridge further including a lip surrounding said front surface. The two components can be planar, forming discs or the like, with the front surface component being permeable to liquid adhesive. The two components are secured in a parallel orientation to form a narrow extrusion space between. A water soluble, tacky substance or adhesive is contained within a combination container-handle or other suitable dispenser. The handle is attached to the lipped cartridge. The container includes the tacky substance and further includes a dispensing means and a tacky substance applying means. The adhesive can be dispensed so as to flow into the extrusion space, thereafter passing through the adhesive-permeable component to coat the collection surface. A benefit is to market the swatter with a clean sanitary cartridge.

Further in accordance with the invention, methods of using the swatters described above for collecting insects and/or other airborne particulates and pests are provided, comprising steps of:

(a) detaching the adhesive-containing handle from the pest collection surface;

(b) dispensing the adhesive;

(c) applying the adhesive onto the collection surface;

(d) reattaching the containment handle;

(e) swatter collecting flying pests; and/or

(f) placing the collection surface where crawling pests traverse;

(g) again detaching the handle from the collection surface; and

(h) disposing of the adhesive surfaced collector or

(i) contacting with water to release the collected objects;

(j) flushing, as down a sewer;

(k) reattaching a clean collection cartridge; and

(l) standing the device with the cartridge on a flat surface clean and adhesive free.

The invention further includes an adhesive dispensing collector for tacky substance collecting of pests and other airborne particulates and methods for using same comprising: a water soluble tacky substance containing handle, stand and adhesive applicator, preferably a dispensing bottle, attached to a dissolvable cartridge, that includes a pest collection surface. Dispensing the tacky substance and further applying the dispensed tacky substance onto the pest collection surface. Swatter collecting flying pests, and/or placing the cartridge where crawling pests traverse. Contacting with an aqueous solvent, wherein the cartridge and tacky substance both dissolve, to further comprise the step of flushing the dissolved cartridge down a sewer and still further standing the dispenser on a surface until further use.

Preferred cartridge materials include water soluble plastics, hard gelatins and water soluble bonded paper products. The dispensed tacky substance is preferably water soluble also, to permit removal of collected pests (alive if desired).

The dispenser as a turn knob screw-actuated plunger bottle also contains and applies the tacky substance as the knob is turned. When the dispenser is attached to a hollow handle extension and the extension in turn is attached to a pest collection surface, the dispensing is through the handle extension. By the addition of a liquid permeable, porous or perforated plate paralleling the cartridge component surface front and being surrounded by a lip, the combination forms an extrusion cavity. The dispensing tacky substance forms a pest collection surface as the tacky substance adhesive exits the cavity, passing through the plate by capillary action or equivalent. The handle attached collector is swatter swung to collect flying pests and is placed where crawling pests traverse to further collect pests. The article is then disposed of or if the cartridge is contacted with water, pests are released alive and the surface is then flushable down a sewer for disposal thereof.

### ADVANTAGES OF THE PRESENTED IMPROVEMENTS

Only the presented pest collection solution includes water washing. The entire collector dissolves. The pests can be released alive. It is a conscious decision to dispose of the collected pests and the dissolved collector down a sewer to dispose thereof. Adhesive swatters have been around for many years. A search of the market finds the adhesive often loses “tackiness” before the consumer can use these devices. Only the cartridge combination of the present invention overcomes the “tackiness” loss by containing the adhesive until point of use. Most adhesive swatters are one time use or complicated pads of adhesive. Replacing pads and subsequently necessary high pricing has been found not to be favored by consumers. Restaurants, hospitals, nurseries and “clean rooms” have outlawed the use of unsanitary adhesive pest collection devices. Adhesive swatters in transport to market and in stores have adhered other merchandise together, creating a very expensive mess.

A water soluble, adhesive containing, dispensing, applying, standable handle is the answer sought by many inventors and consumers. The containing of adhesive until point of use overcomes the problems associated with all previous adhesive collectors. The adhesive containing handle, cartridge, stand based, swatter is simple to use, sanitary, inexpensive and humane in use. The dissolvable collector of the present invention solves the problems of unsanitary disposal inherent in the prior technology without added complications. It is sanitary and simple enough to be used by children and in hospitals, restaurants and “clean room” environments. No unsanitary dead smashed fly needs to be picked up. Application of adhesive at the time of use will make this invention accepted and used. The water soluble cartridge further extends the advantages. The selection of adhesives is extended because the choice does not need to be a non-drying adhesive as with all pre-applied adhesive swatters.

From the open hand of cave man to a rolled up newspaper smashing of flies and like pests, to inhumane adhesive sticking of pests, a barrage of inventions too numerous to mention have received patents. The smashing method and adhesive trap method both leave room for improvement. No invention found combined water soluble adhesive, contained and applied from a swatter handle grip, preferably through the swatter handle attaching means. No swatter mentioned disclosed water soluble collection elements or flushing down a sewer. Smashing pests causes spread of disease and is disgusting to view.

Whether conventional mouse traps, fly swatters or “fly paper”, none satisfy all the needs of modern society. Adhesive collection dooms pests to a very inhumane death if used quickly after manufacture. Otherwise, they do not work at all because the adhesive loses tack before the device can be delivered to the marketplace. Furthermore, the effectiveness of use is reduced by the delay until use thereof. Insecticides have proven disastrous to mankind. The need for improved pest control methods which are inexpensive, sanitary, and safe for use in all environments escape the attempts for improvements presented by thousands of inventions.

Only the presented devices overcome these drawbacks in a way as inexpensive and simple as the spring on a board trap. An invention that dissolves to release pests alive and is flushable down a sewer is the answer sought by many inventions. The addition of a dispenser in combination with the soluble collector further enhances the usefulness, sanitation and convenience of use. Animal, insect and caricature shaped adhesive dispensers add novelty and consumer appeal.

### BRIEF DESCRIPTION OF THE DRAWINGS

The drawings constitute a part of this specification and include exemplary embodiments of the invention, which may be presented in various forms. It is to be understood that in some instances various aspects of the invention may be shown in exaggerated or enlarged form to facilitate an understanding of the invention. In the present drawings:

FIG. 1 is a plan view of the invention cartridge.

FIG. 2A is a face view of the squeeze bottle through handle dispensing swatter.

FIG. 2B is a cross-sectional side view of the squeeze bottle handle swatter.

FIG. 3 is a side view of a gravity flow dispensing swatter, also depicting the attaching means as a unitary swatter.

FIG. 4 is a plan view of a mini finger-actuated plunger dispenser designed for restrictive environments such as automobile use (to mount on a dashboard) and restaurant use to stand on a table as a clean cartridge and disposal thereof.

FIG. 5 is a plan view illustrating the dispenser holder grip embodiment, also illustrating the bent tab lip clip.

FIG. 6 is a side view of a clear turn knob applicator.

FIG. 7 is an illustration of a method of disposal of the water soluble cartridge.

FIG. 8 is a cross sectional view of the handle attached pest collection cartridge.

FIG. 9 is a cross sectional view of the handle detached cartridge.

FIG. 10 is a plan view of a device incorporating multiple adhesive-dispensing components in an extended handle.

FIG. 11 illustrates a means of attaching the adhesive-dispensing components of FIG. 10 together to extend the handle.

### DETAILED DESCRIPTION OF PREFERRED EMBODIMENTS

Detailed descriptions of certain preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

For example, while various embodiments of the invention are described in terms of collecting and disposing of various flying or creeping insect pests, these and other embodiments can also be used for collecting and disposing of small mammals such as mice, rats and bats. Additionally, the devices can be used for collecting live specimens of insects, birds and small mammals by zoologists, entomologists and lepidopterists. Such live specimens can also be used for food by animals or even humans, or for live fishing bait.

In the specification, the term “and/or” may be used in the conventional sense, wherein “A and/or B” signifies A and B may be present either individually or together. Reference will be made to tacky substances used for collection of pests, which can be conventional adhesives or various natural or synthetic materials such as molasses which have tacky qualities but do not cure or harden as is desired with conventional adhesives. For convenience, these materials may be collectively or generically referred to as adhesives. Whether described as adhesives or other tacky substances, these materials are preferably water soluble to facilitate collection and disposal of pests.

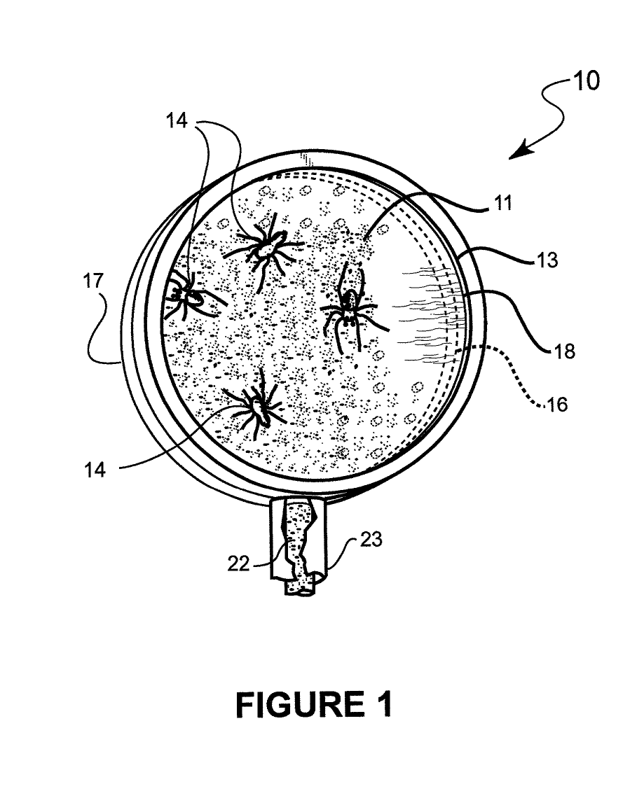

Referring to FIG. 1, an article of manufacture for adhesively collecting pests (i.e., a swatter) is partially shown, depicting the process of use and a used invention cartridge 10, comprising two planar component surfaces surrounded by a lip 13. Shown is one component, a front surface 16 covered with adhesive 11 and the other, an opposed back component 17 (not seen in this view). At 18, a portion of the adhesive 11 is shown removed to expose front surface 16 covered by a paper liner 18. Cartridge 10 is shown as comprising two substantially round planar components encircled by a round lip, as this is a conventional shape for an insect swatter and the components are easy to fabricate in this shape. However, if desired, the planar components and lip can be square, rectangular, oval, oblong or any other shape which is considered suitable, including shapes of polygons such as hexagons or octagons.

Crawling pests 14 are collected, adhering to the adhesive 11, by placing the cartridge 10 where crawling pests 14 traverse. The adhesive initially tried was a non-drying (and non-soluble) adhesive 11 known as Stik-em™ as trade marked and available from Seabright Laboratories of Emeryville, Calif. A dissolvable, disposable paper liner 18 is optionally included in this embodiment.

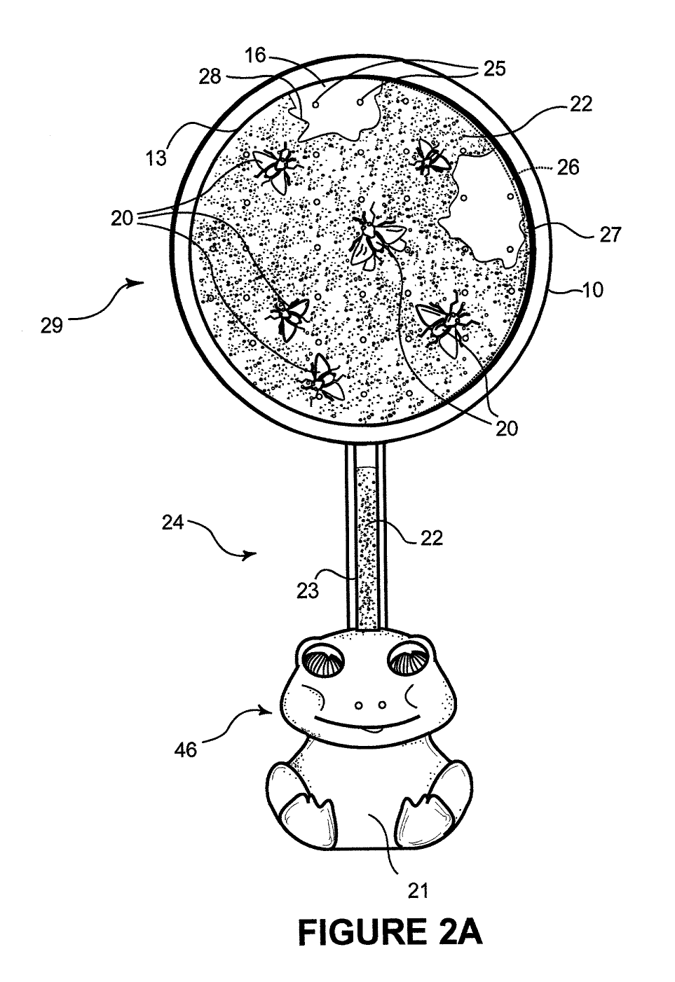

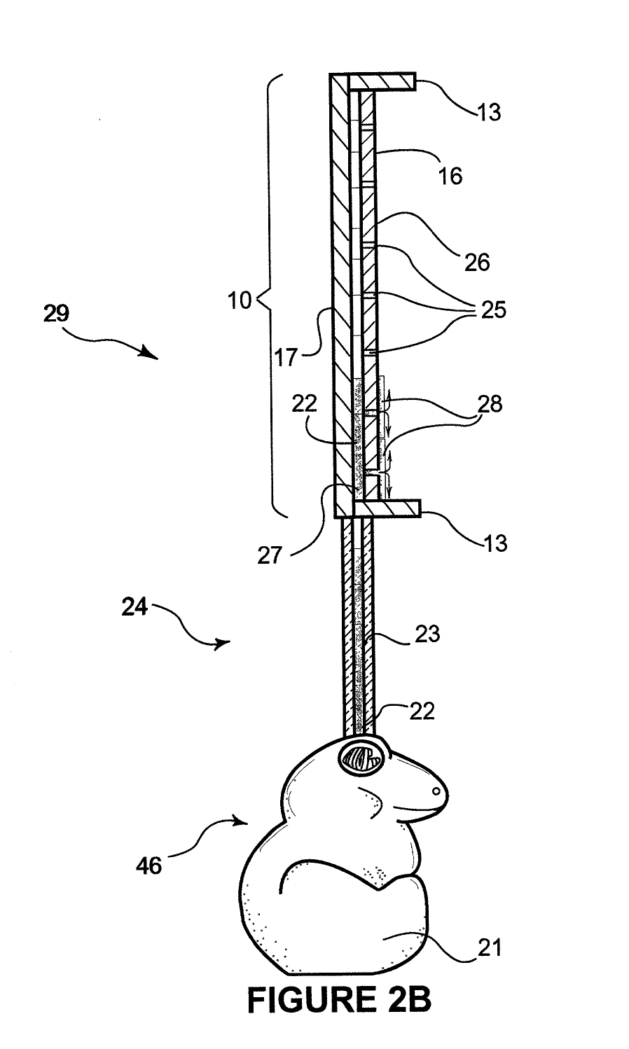

FIGS. 2A and 2B show a cartridge 10 and squeeze bottle 21 (as dispenser 46) attached thereto to form a swatter assembly 29 wherein the bottle 21 can be squeezed, forcing in this case, water soluble tacky substance 22, (e.g., a molasses based composition), through a hollow or lumen 23 in handle extension 24. The level of substance 22 within handle extension 24 is visible because the walls of extension 24 are translucent or transparent. The extruded substance 22 exits hollow or lumen 23 in handle extension 24 onto cartridge 10 and front surface 16, flowing as extruded between front surface 16 and a porous or adhesive-permeable plate 26 paralleling front surface 16. The plate 26 is surrounded by a lip 13 forming an extrusion cavity 27. (See FIG. 2B.) As the cavity 27 fills with the extruded water soluble substance 22, the substance 22 spreads over the to front surface 16 and oozes through plate 26 and orifices 25 (or other porosities or passages), thereby creating a pest collection tacky surface 28 on front surface 16 and plate 26. The swatter 29 with dispensed tacky substance 22 exposed is then swatter swung to collect flying pests 20, which adhere thereto. As shown, dispenser 46, in this embodiment squeeze bottle dispenser 21, can take the form of a frog or other animal or caricature figure, to add consumer appeal.

Adhesive or tacky substance 22 can be colored (e.g., red) to suggest a frog's outstretched tongue, provided that the handle extension 24 is transparent or translucent to allow visibility. Porous plate 26 can also be transparent or translucent, to allow visibility of the colored substance 22 as it reaches the cartridge and emerges from plate 26 onto surface 16. For some pests, colors can also be used to make surface 16 and the adhesive spread thereon attractive. For example, the surface and/or adhesive can be red, yellow or various shades of yellow-green, as disclosed in U.S. Pat. No. 4,899,485. As disclosed in that same patent, pictures of insects can also be imprinted upon the exterior surfaces of the swatter, e.g., surface 16, to serve as an optical attractant.

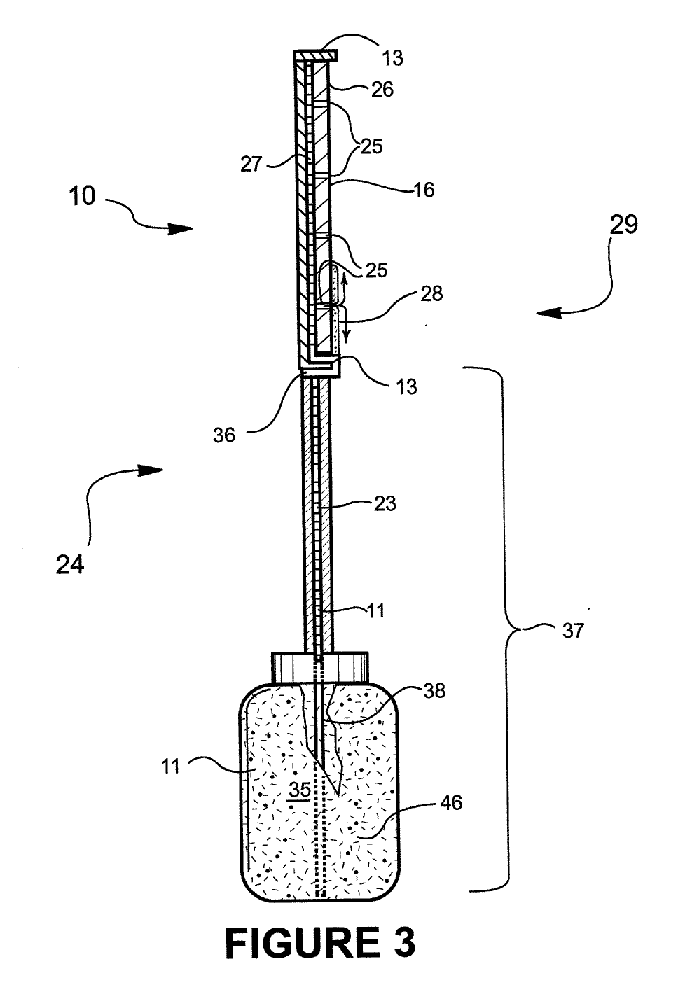

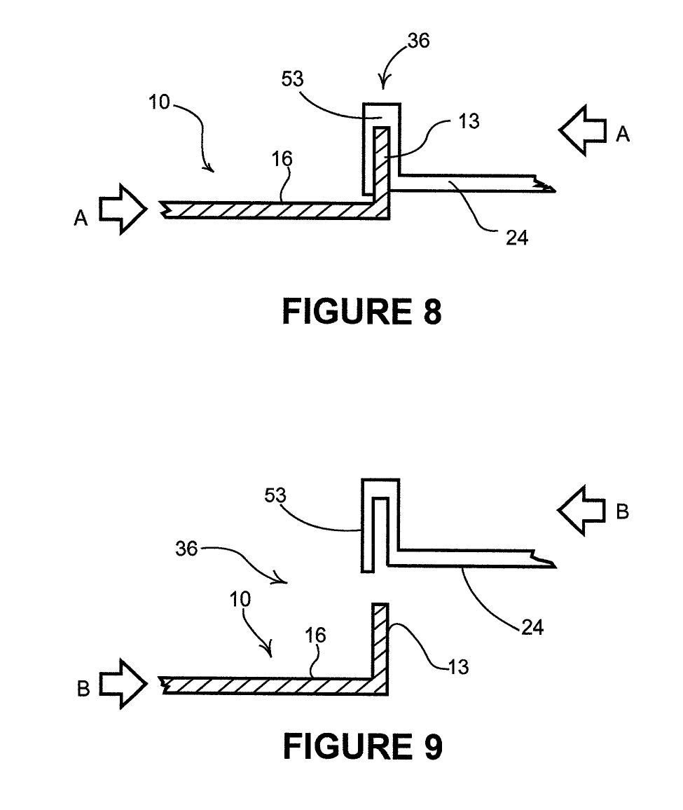

FIG. 3 depicts a bottle embodiment 35 of dispenser 46 for a more fluid adhesive 11 wherein the diameter of the hollow 23 in handle 24 determines the rate of gravity flow from the bottle 35 of adhesive 11 as the swatter assembly 29, including bottle 35, is inverted. The bottle 35 and attached handle 24 are fastened to form swatter assembly 29 by bent tab lip clip attaching means 36 (shown in detail in FIGS. 8 and 9). As shown, adhesive 11 has been allowed to flow by gravity through hollow 23 into extrusion cavity 27, thence through orifices 25 by capillary action to form a sticky surface coating 28 upon surface 16 of cartridge 10. By the addition of optional tube 38 within bottle 35, adhesive 11 can be forced into hollow or lumen 23 and cavity 27 by squeezing bottle 35. The dispenser 46 and extension 24 make up handle 37.

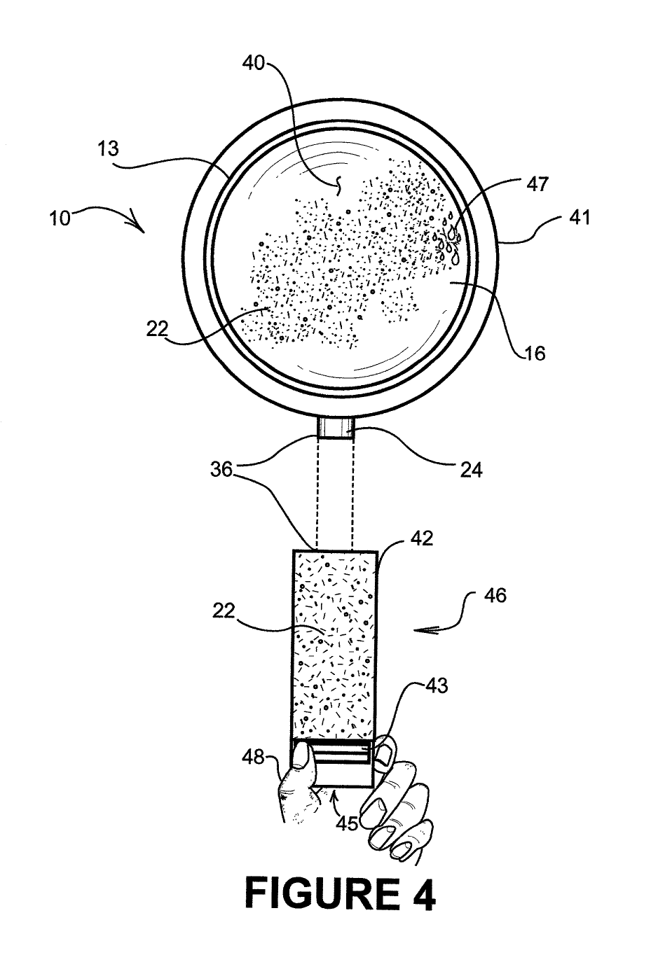

Viewing FIG. 4, a human's finger 48 actuating plunger 43 of dispenser 46 is illustrated. A preferred embodiment for swatter assembly 29 comprises a small dispenser/applicator 42 similar to “glue stick dispensers” commonly used in offices and homes and containing adhesive 22. Such dispensers can also be constructed like the ointment container with finger actuated piston disclosed in U.S. Pat. No. 4,169,547. Differing from such dispensers is the cartridge 10 or cup 40 shaped cartridge 10 holding hoop 41 encircling lip 13. Disposable plates or cups of plastic, gelatin or paper materials, preferably water soluble, are produced to fit within lip 13 in place of the conventional planar disk components, and are retained in place by hoop 41. Hoop 41 can be any flexible, springy or elastic material which will hold the cup 40 in place, or can also comprise cords which are tied or strips of hook-and-loop fabric (e.g., Velcro™) which can be secured in place.

The steps of use for this embodiment comprise:

(a) detaching dispenser 46 from handle 24,

(b) dispensing, in this case, adhesive 22 by using dispenser 46 as an applicator 42 to apply adhesive directly to the cartridge 10 cup 40, front surface 16;

(c) then reattaching dispenser 46 as a handle for swatter 29, using attachment means 36.

(d) Swatter collecting flying pests 20 (as shown in FIG. 2A) and/or crawling pests 14 (FIG. 1).

(e) Standing the dispenser on the dispenser's base 45 until further use.

(f) Finally, disposing of the collections comprises the step of,

(g) contacting the device with water 47 wherein adhesive 22 and cup 40 both dissolve, releasing the crawling 14 and flying pest 20 collections. The water soluble cup 40 with crawling 14 and flying pest 20 collections, is flushable.

The cup 40 and other dissolvable parts of cartridge 10 can be manufactured from water soluble plastic resins as one alternative, from hard gelatin as a second alternative and water soluble bonding agent adhered paper as a third alternative. The paper can be formed into a cartridge or a liner for the cartridge face.

Water-soluble polymers include various natural gums, e.g., arabic, tragacanth and karaya, and are typically complex carbohydrates of the sugar group. Semisynthetic water-soluble polymers (also called water-soluble resins) include such chemically treated natural polymers as carboxymethylcellulose, methylcellulose and other cellulose ethers, as well as various kinds of modified starches (e.g., ethers and acetates). Some of these natural or semisynthetic polymers are also biodegradable. Synthetic water-soluble polymers include polyvinyl alcohols, ethylene oxide polymers, polyvinylpyrrolidones and polyethyleneimines. Suitable water-soluble plastics include hydroxyalkyl cellulose materials such as the hydropropyl cellulose disclosed in U.S. Pat. No. 4,136,798 and polyvinyl alcohol and polyvinylpyrrolidone materials disclosed in U.S. Pat. No. 4,144,760. Both these patents are incorporated herein by reference. Also useful are the various polymers and copolymers of N-vinyl lacatams disclosed in U.S. Pat. No. 4,644,020, which is incorporated herein by reference.

Attachment means 36 can be the bent tab lip clip mechanism described above and illustrated in FIGS. 8 and 9, other suitable mechanical fasteners such as threaded connectors or quick-connect devices, or combinations of hook-and-loop fabric fasteners such as Velcro™.

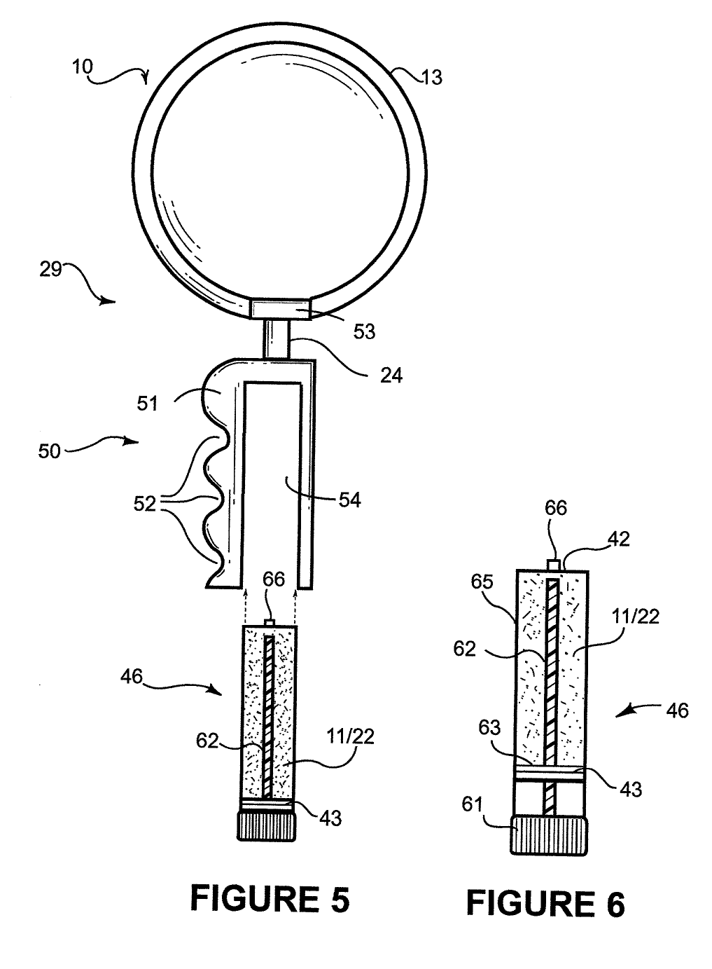

FIG. 5 depicts a handle 50 containing adhesive dispenser 46 within a holder embodiment, further comprising a handle grip 51 with finger indentations 52. The bent tab lip clip 53 attached to handle extension 24 springily catches the lip 13 of cartridge 10, thereby attaching cartridge 10 to dispenser 46 and handle 50 to form swatter assembly 29. The space 54 in holder 50 for dispenser 46 can be partially open as shown, or completely enclosed. Dispenser 46 can be a press fit in space 54, or suitable clips or other restraining devices can be provided (not shown here).

FIG. 6 illustrates a larger turn knob-actuated dispenser 46 in detail, depicting a unitary turn knob 61 which rotates lead screw 62 to move plunger 43, encasing threaded nut 63, fitting the lead screw 62, inside a containing shell 65, containing adhesive 11, or water soluble tacky substance 22. The adhesive 11 or substance 22 is dispensed as knob 61 is turned. The turning of knob 61 rotates lead screw 62, thereby engaging plunger 43 encased by nut 63 and actuating plunger 43, in turn extruding adhesive 11 or substance 22. When lower viscosity adhesives are used, an optional restrictor 66 is emplaced, sized to prevent adhesive flow through applicator 42 when the dispenser is not in use.

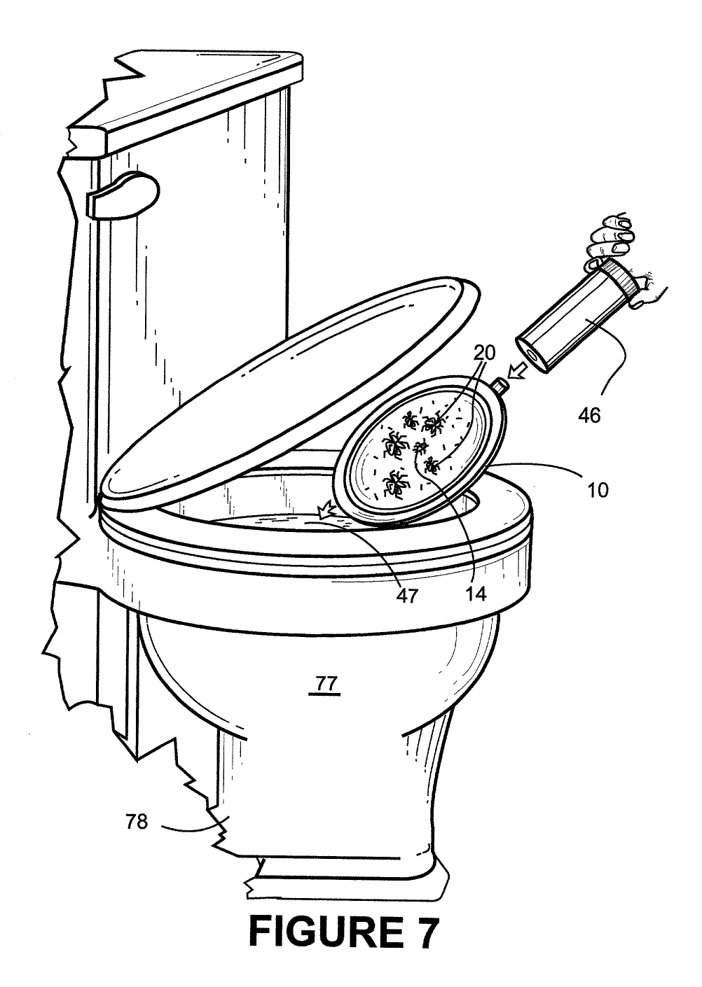

FIG. 7 illustrates the disposal of the used cartridge 10 and adhered pests 14 and 20 by dissolving and subsequently flushing down a toilet 77 filled with water 47 and sewer 78, after detaching dispenser 46.

FIG. 8 is a cross section A/A view depicting an attaching means 36 of FIGS. 3, 4 and 5. The bent tab lip clip 53 springily catches a lip 13 of collector 10, thus combining the collection surface 16 with an applicator 42, adhesive containing dispenser 46 or extension 24 thereof.

FIG. 9 illustrates a cross section B/B view of a detached bent tab lip clip 53 disconnected from lip 13 of a collecting cartridge 10. Clip 53 can be manufactured of a springy plastic, metal or other suitable materials.

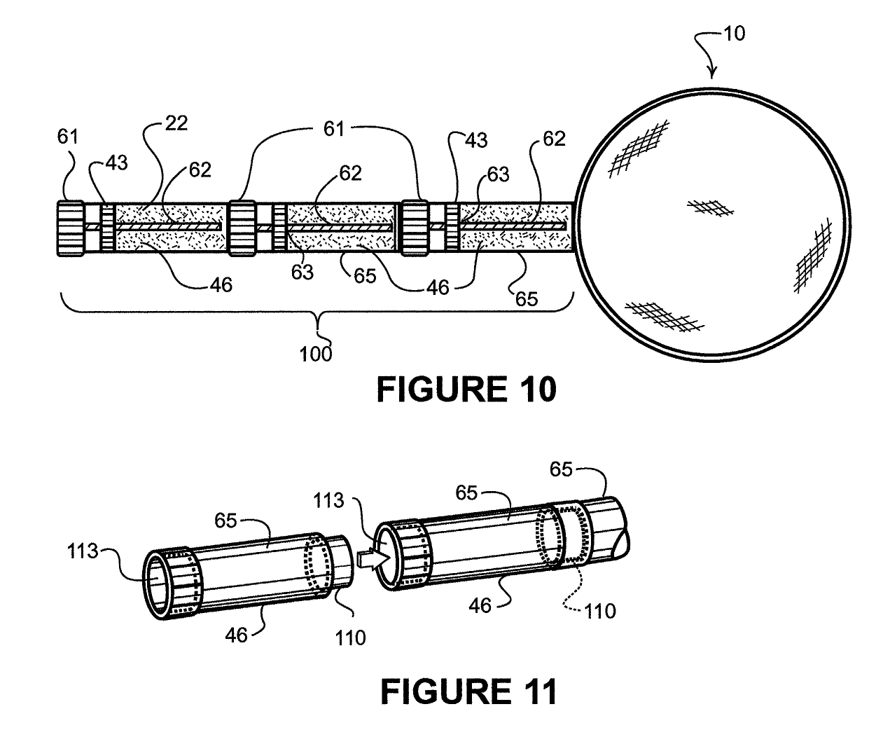

FIG. 10 depicts an improved design for a fly swatter handle comprising multiple adhesive dispensers 46 detachably combined to form a longer swatter handle 100. Two or more dispensers can be combined. The dispensers 46 can be knob-actuated types as illustrated in FIGS. 5 and 6, comprising knobs 61 to actuate plungers 43, or any other suitable type of dispenser which can be thus adjoined to form an extended swatter handle. Having multiple dispensers joined to form an extended handle provides more range for swatting flying insects, as well as providing spare dispensers containing adhesive 22. Multiple types of adhesives or other tacky substances can be provided in the dispensers to allow their selection for particular collection missions.

FIG. 11 is a cross sectional view of adhesive dispensers 46 designed to combine, with interlock 110 to be inserted as a press fit into void 113 to form the extended handle of FIG. 10. Any suitable mechanical means can be used for interconnecting such dispensers 46 to form a lengthened handle.

Any suitable type of water-soluble adhesive 22 can be used in the various embodiments of the invention, provided it is fluid enough to flow through the dispenser and be applied to collecting surfaces as described below. The adhesive should, however, be viscous enough to adhere to the surfaces of the device rather than flying off when the swatter is in use. Non-drying adhesives can be used when the swatter is to be used over a long period of time or left in place to trap creeping pests. On the other hand, adhesives such as polyvinyl alcohol which dry in a relatively short time can also be used, since the adhesive is dispensed and applied to the collecting surface of the device just before use and washed off or discarded soon after use. Any number of naturally sticky products can be used, including honey, molasses, sorghum and other sugary syrups; water soluble natural gums and rosins. Natural rubber can be admixed with additives such as diesel oil to prepare a suitable adhesive, as disclosed in Chinese published application CN 1067255A. Paloja, a tradename for a chicle-based gum, is commercially available from the L.A. Dreyfus Company of South Plainfield, N.J. Abalyn includes a viscous liquid derived from rosin, which is nondrying and available from Hercules Powder Company of Wilmington, Del.

A variety of synthetic adhesives, both non-drying and air-drying, can be used, provided their contents are not hazardous in the environment where used. U.S. Pat. No. 4,411,093 discloses a suitable non-drying adhesive, and U.S. Pat. No. 4,424,642 discloses a suitable water-strippable adhesive. Both of these patents are incorporated herein by reference. Tanglefoot™ Adhesive, available from the Tanglefoot Company of Grand Rapids, Mich., is a non-drying adhesive suitable for collecting flies and mosquitoes. Another suitable nondrying adhesive is commercially available from H.B. Fuller of Hayward, Calif. as Formula S.F. 858 (See U.S. Pat. No. 4,126,959).

Adhesive preparations comprising polyvinyl alcohol can be used, provided they are periodically rehydrated, as disclosed in U.S. Pat. No. 5,243,864, which is incorporated herein by reference. Water strippable adhesive compositions comprising ethylene vinyl acetate or oxidized ethylene vinyl acetate and polyvinyl alcohol are disclosed in U.S. Pat. No. 4,424,642, which is incorporated herein by reference. Polybutene-based water-soluble adhesive compositions are disclosed in U.S. Pat. No. 4,411,093, which is also incorporated herein by reference.

Various types of water-soluble adhesives or tacky substances having different viscosities, tack characteristics and drying times can be prepared for use in the embodiments of the invention described above, each being tailored to an expected type of collection. Such adhesives can be packed in dispensers for use with the swatter assemblies of the invention, and provided in sets containing various types of adhesives for the expected uses. The dispensers can be designed to interlock to form a handle as illustrated in FIGS. 10 and 11, or simply provided as an assortment to be mounted and used individually according to the occasion. Each dispenser, when selected and incorporated into the swatter assembly, dispenses and applies the appropriate adhesive for the collection mission. Many suitable adhesives, as described above, are commercially available from various companies, and can be selected for specific uses with the apparatus of the invention. Many types of containers can be used for the storage and dispensing of the adhesives, including bottles, cans, tubes and aerosol containers. In some cases, brushes or other applicators may be required.

In addition to selecting or designing adhesives for their viscosity, tack, etc., they can be enhanced by adding various materials to alter their color and/or odor to make them attractants for various types of insects or other creatures to be collected. For example, U.S. Pat. No. 4,899,485 discloses insect attractants based upon natural materials such as yeast, egg, milk and meat extracts. Natural or synthetic versions of well-known attractants such as vanillin can also be used. Numerous synthetic fly attractant compositions comprising at least one volatile short chain carboxylic acid, at least one organic sulfide and at least one nitrogen heterocyclic compound are disclosed in U.S. Pat. No. 6,106,821, which is incorporated herein by reference. Some of these compositions approximate the odors of various animal manures.

Additionally, the collecting surface and/or adhesive can contain materials which alter the light reflecting properties thereof, such as the luminescent materials disclosed in U.S. Pat. No. 4,411,093. In addition to luminescent materials (or to enhance their effects), the swatter cartridges can incorporate chemiluminescent capsules which will produce light of various colors, as disclosed in U.S. Pat. No. 6,155,002, which is incorporated herein by reference. Such capsules are commercially available under the tradename CYALUME, a registered trademark of Cytec Technology Corp. which was exclusively licensed to Omniglow Corporation.

While commercially available adhesive dispensers can be used to dispense and apply the adhesive and serve as handles for the swatters of the invention, squeeze containers such as bottles and tubes can also be used. To add popular appeal to the product, such squeeze containers can take the form of suitable animals, humans, insects or caricatures thereof as illustrated in FIGS. 2A and 2B.

While the invention has been described in connection with certain preferred embodiments, it is not intended to limit the scope of the invention to the particular forms set forth, but on the contrary, it is intended to cover such alternatives, modifications, and equivalents as may be included within the spirit and scope of the invention as defined by the appended claims.

What is claimed is:

1. an adhesive-dispensing swatter for adhesively collecting objects comprising:
substantially, a two planar component cartridge, one component comprising a liquid-permeable material and forming a predetermined front collection surface and the second component forming a solid back surface parallel thereto, with a lip encircling both said components to hold them in parallel orientation to form a narrow extrusion space between said components;
at least one adhesive source attached to said cartridge;
means for dispensing said adhesive from said source into the narrow extrusion space between said components and thereby applying same to said front collection surface via said liquid-permeable material, wherein said means for dispensing and applying said adhesive form an adhesive-containing swatter handle attached to said cartridge, and wherein
the resulting combination forms a swatter which collects objects including pests in said adhesive applied to said front surface.

2. A swatter for adhesively collecting objects as claimed in claim 1 wherein said cartridge components including the lip are water soluble.

3. The swatter of claim 2 wherein said cartridge comprises at least one water soluble plastic.

4. The swatter of claim 2 wherein said cartridge comprises a hard gelatin.

5. The swatter same of claim 2 wherein said cartridge comprises a water soluble bonded paper.

6. The swatter of claim 1 wherein said adhesive means is a water soluble tacky substance, which can be dissolved to release collected objects.

7. The swatter of claim 1 wherein said handle forms a base upon which the swatter can stand.

8. The swatter of claim 7 wherein said containment handle base forms a bottle.

9. The swatter of claim 8, wherein means for attaching comprises a substantially springy bent tab lip clip extending from said bottle and said bent tab springingly clip catches said lip, thereby attaching said cartridge to said handle stand.

10. The swatter of claim 8, further comprising a hollow handle extension interconnecting said dispenser and said cartridge, whereby the dispensing of said adhesive is through said hollow.

11. The swatter of claim 8 wherein said bottle is a squeeze container.

12. The swatter of claim 11, further comprising a hollow handle extension interconnecting said dispenser and said cartridge, whereby the dispensing of said adhesive is through said hollow.

13. The swatter of claim 1, wherein said adhesive source comprises a plunger-actuated dispenser.

14. The swatter of claim 13 wherein said dispenser is a turn knob plunger-actuated dispenser.

15. The swatter of claim 14, further comprising a hollow handle extension interconnecting said dispenser and said cartridge, whereby the dispensing of said adhesive is through said hollow.

16. The swatter of claim 15, further comprising:
a liquid adhesive-permeable plate paralleling said cartridge component front, surrounded by the lip, said lip, surface and plate forming an extrusion cavity;
whereby said adhesive is spread, forming a tacky collection surface as said dispensed adhesive is extruded through said hollow and exits through said permeable plate.

17. A method of collecting pests with a swatter of claim 1, comprising steps of:
(a) dispensing water soluble adhesive from said adhesive source and thereby applying same to said front collection surface;
(b) causing pests to adhere to the adhesive thus applied; and
(c) removing the collected pests from said adhesive with water.

18. A method of collecting pests with a swatter of claim 9, comprising steps of:
(a) detaching the adhesive containing handle from the collection surface;
(b) dispensing said adhesive;
(c) applying said adhesive onto said collection surface;
(d)reattaching said handle to said collection surface;
(e) swatter collecting flying pests and/or placing said swatter where crawling pests traverse;
(f) detaching said handle from said collection surface; and
(g) disposing of said collection surface with collected pests attached.

19. A method of collecting pests with a swatter of claim 9, comprising steps of:
(a) detaching said handle from said pest collection surface;
(b)applying said adhesive onto said collection surface;
(c)reattaching said handle to said surface;
(d)swatter collecting flying pests and/or placing said swatter where creeping pests traverse;
(e) contacting said collection surface with an aqueous solvent;
whereby at least said adhesive dissolves, releasing the collected pests alive; and thereafter,
(f) disposing of or reusing said pest collection surface.

20. The method of claim 19 wherein said pest collection surface is disposed of by flushing the dissolved collector down a sewer.

21. The method of claim 19 wherein additional adhesive is applied to said collection surface for further collection of pests.

22. The method of claim 19, further comprising a step of reattaching a clean pest collection surface, then dispensing and applying said adhesive to resume the pest collection process.

23. An adhesive-dispensing swatter for adhesively collecting objects comprising:
a two planar component cartridge, one component comprising a liquid adhesive-permeable plate forming a predetermined front collection surface and the second planar component forming a solid back surface parallel thereto, with a lip encircling both said planar components to hold them in parallel orientation to form a narrow extrusion space between said planar components,
wherein said planar components and said lip are all water soluble;
at least one adhesive source attached to said cartridge;
means for dispensing said adhesive from said source into said narrow extrusion space and thereby applying same to said front collection surface via said adhesive-permeable plate, wherein
said means for dispensing and applying said adhesive form an adhesive-containing swatter handle, and wherein
the resulting combination forms a swatter which collects objects including pests in said adhesive applied to said collection surface.

24. The swatter of claim 23 wherein said adhesive source is a bottle and said dispensing means comprise a passage connecting said bottle to said extrusion space.

25. The swatter of claim 23 said adhesive source comprises at least one adhesive dispenser which can be removed from said swatter handle to dispense adhesive directly onto said collection surface and thereafter reattached to said handle.
